(19) United States
(12) Patent Application Publication
(10) Pub. No.: US 2015/0080048 A1
(43) Pub. Date: Mar. 19, 2015

(54) MOBILE TERMINAL AND ABNORMAL CALL PROCESSING METHOD THEREFOR

(71) Applicants: Wen Fang, Shenzhen City (CN); Lianfang Huang, Shenzhen City (CN)

(72) Inventors: Wen Fang, Shenzhen City (CN); Lianfang Huang, Shenzhen City (CN)

(73) Assignee: ZTE CORPORATION, Shenzhen City, Guangdong (CN)

(21) Appl. No.: 14/394,209

(22) PCT Filed: Jun. 25, 2012
(86) PCT No.: PCT/CN2012/077450

§ 371 Date: Oct. 13, 2014

(30) Foreign Application Priority Data
Apr. 16, 2012 (CN) 201210111242.9

(51) Int. Cl. H04M 1/725

(52) U.S. Cl. CPC H04M 1/72569; H04W 88/02
USPC 455/550.1

(57) ABSTRACT

A mobile terminal and an abnormal call processing method thereof relate to the field of communications. The method includes: in the process of a voice call, a mobile terminal detecting whether the mobile terminal is in an idle call state in real time, and when it is detected that the mobile terminal is in the idle call state, in accordance with a preset mode, prompting a user that the voice call has ended, or automatically hanging up the voice call, or hanging up the voice call after prompting the user that the voice call has ended. The present application also discloses a mobile terminal. The technical solution of the present application solves the problem of wasting the telephone expenses of a user caused by an ultra-long call because both sides on a call do not hang up the call in time, thereby improving the user experience.

### TECHNICAL FIELD

The present invention relates to the field of communications, and in particular, to a mobile terminal and an abnormal call processing method thereof.

### BACKGROUND OF THE RELATED ART

With the continuous development of terminal technology and the popularity of mobile phones, users increasingly depend on mobile phones, of which one of the most commonly used functions is a voice call function.

However, in the process of a call, the following condition often occurs. After a call has ended, both sides forget to hang up the call due to various reasons, or do not hang up successfully, which results in the mobile phone being idle for a long time and the call being in progress. Especially in the process of a call between a mobile phone and a telephone, sometimes the mobile phone is in an idle call state for a long time since the telephone has not been put in a right place. This wastes the user's expenses, and more importantly, the user of the mobile phone can not find that there is another incoming call in this period of time.

### SUMMARY OF THE INVENTION

The technical problem to be solved by the present invention is to provide a mobile terminal and an abnormal call processing method thereof, so as to solve the problem that a normal voice call is influenced since a mobile phone is in an idle call state for a long time.

In order to solve the above technical problem, the present invention discloses an abnormal call processing method of a mobile terminal, comprising:

in the process of a voice call, a mobile terminal detecting whether the mobile terminal is in an idle call state in real time, and when it is detected that the mobile terminal is in the idle call state, prompting in accordance with a preset mode a user that the voice call has ended, or automatically hanging up the voice call, or hanging up the voice call after prompting the user that the voice call has ended.

Preferably, in the method, the process of the mobile terminal hanging up the voice call after prompting in accordance with a preset mode the user that the voice call has ended comprises:

the mobile terminal prompting the user that the voice call has ended in accordance with a preset mode, and if an operation instruction of ending the voice call initiated by the user has not been received within set duration or when a number of prompts has achieved a set value, automatically hanging up the voice call.

Preferably, in the method, the process of detecting whether the mobile terminal is in an idle call state comprises:

in the process of a voice call, the mobile terminal detecting input and output audio signals in real time, and if the input and output audio signals have not been detected within set duration, determining that the mobile terminal is in the idle call state.

Preferably, in the method, if the input or output audio signal is detected, judging whether a frequency and/or intensity of the detected audio signal is within a human voice range, and if the frequencies or intensities of all the detected audio signals exceed the human voice range within set duration, determining that the mobile terminal is in the idle call state.

Preferably, the method further comprises:

in the process of a voice call, a gravity sensor in the mobile terminal detecting X, Y and Z values of the mobile terminal in real time, and only if the detected X, Y and Z values are not changed within set duration, detecting that whether the mobile terminal is in the idle call state.

Preferably, in the method, the process of detecting whether the mobile terminal is in an idle call state comprises:

in the process of a voice call, a gravity sensor in the mobile terminal detecting X, Y and Z values in real time, and if the detected X, Y and Z values are not changed within set duration, determining that the mobile terminal is in the idle call state.

The present invention further discloses a mobile terminal, comprising:

a detection unit, configured to in the process of a voice call, detect whether the mobile terminal is in an idle call state, and when it is detected that the mobile terminal is in the idle call state, notify a voice call module that the mobile terminal is in the idle call state;

the voice call module, configured to: upon receiving the notification that the mobile terminal is in the idle call state, prompt in accordance with a preset mode a user that the voice call has ended, or automatically hang up the voice call, or hang up the voice call after prompting the user that the voice call has ended.

Preferably, in the mobile terminal, the voice call module is configured to: when hanging up the voice call after prompting the user that the voice call has ended, firstly prompt the user that the voice call has ended in accordance with a preset mode, and if an operation instruction of ending the voice call initiated by the user has not been received within set duration or when a number of prompts has achieved a set value, automatically hang up the voice call.

Preferably, in the mobile terminal, the detection unit comprises:

a voice recognition module, configured to detect input and output audio signals in real time in the process of a voice call,

a judgment module, configured to determine that the mobile terminal is in the idle call state when the input and output audio signals have not been detected by the voice recognition module within set duration.

Preferably, in the mobile terminal, the voice recognition module is further configured to detect a frequency and/or intensity of an input or output audio signal when the audio signal is detected;

the judgment module is configured to determine that the mobile terminal is in the idle call state when the voice recognition module detects that the frequency and/or intensity of the audio signal exceeds the human voice range within set duration.

Preferably, the mobile terminal further comprises:

a gravity sensor, configured to detect X, Y and Z values of the mobile terminal in real time in the process of a voice call;

the detection unit, configured to detect whether the mobile terminal is in the idle call state only if the X, Y and Z values detected by the gravity sensor are not changed within set duration.

Preferably, in the mobile terminal, the detection unit comprises:

a gravity sensor, configured to detect X, Y and Z values of the mobile terminal in real time in the process of a voice call;

a judgment module, configured to determine that the mobile terminal is in the idle call state when the X, Y and Z values detected by the gravity sensor are not changed within set duration.

The technical solution of the present application solves the problem of wasting the telephone expenses of a user caused by an ultra-long call because both sides on a call do not hang up the call in time, thereby improving the user experience.

### BRIEF DESCRIPTION OF DRAWINGS

The accompanying drawings described herein are used to provide a better understanding of the present invention and constitute a part of this application, and the schematic embodiments of the present invention and the descriptions thereof are used to explain the present invention and do not constitute an improper definition of the present invention. In the accompanying drawings:

FIG. 1 is a flowchart of prompting an abnormal call through a motion state according to an embodiment;

FIG. 2 is a flowchart of prompting an abnormal call through an audio input according to an embodiment; and

FIG. 3 is a flowchart of prompting an abnormal call by combining the two methods according to an embodiment.

### PREFERRED EMBODIMENTS OF THE PRESENT INVENTION

The technical schemes of the present invention will be described in detail below in conjunction with accompanying drawings. It should be illustrated that, in the case of no conflict, the embodiments of this application and the features in the embodiments could be combined randomly with each other.

### Embodiment One

The applicant of the present application finds that when an existing mobile terminal is in an idle call state for a long time (i.e., a voice call end operation is not performed after a user ends a voice call), it will results in the mobile terminal not continuing to perform a normal voice call. Therefore, the applicant proposes for the first time that a voice state of both sides on a call and/or a motion state of a mobile phone is detected to judge whether the mobile phone is in an idle call state (also referred to as an abnormal call state) and prompt the user in time.

For example, the applicant proposes that:

A first time threshold is set, and if the mobile phone is still in the idle call state for a long time after the time is larger than the threshold, the sides on a call (i.e., users) are prompted in a form of text, picture, voice or video. Wherein, the first time threshold and the prompting mode may be preset by a user.

On basis of the above idea, the present embodiment provides an abnormal call processing method of a mobile terminal, comprising:

in the process of a voice call, a mobile terminal detecting whether the mobile terminal is in an idle call state in real time, and when it is detected that the mobile terminal is in the idle call state, in accordance with a preset mode, prompting a user that the voice call has ended, or automatically hanging up the voice call, or hanging up the voice call after prompting the user that the voice call has ended.

The specific process of hanging up the voice call after prompting the user that the voice call has ended comprises: after the mobile terminal prompts the user that the voice call has ended in accordance with a preset mode, the mobile terminal further monitoring whether an operation instruction of ending the voice call initiated by the user has been received within set duration or when a number of prompts has achieved a set value, and if the operation instruction has not been received, automatically hanging up the voice call.

Wherein, the mode of detecting whether the mobile terminal is in the idle call state may comprise in the process of a voice call, detecting an input audio signal (i.e., voice input through the local phone) and an output audio signal (i.e., a voice input through the counterpart phone) in real time, and if the input and output audio signals have not been detected within set duration (i.e., said first time threshold), determining that the mobile terminal is in the idle call state.

if the input or output audio signal is detected, it is continually judged whether a frequency and/or intensity of the detected input or output audio signal is within a human voice range, and if the frequencies or intensities of all the detected audio signals exceed the human voice range within set duration, determining that the mobile terminal is in the idle call state.

For said mode of detecting whether the mobile phone is in the idle call state, it needs to be further described below:

At present, ordinary people can hear the sound wave in the frequency range of 20 HZ-20 KHZ. The sound wave is an infrasound when its frequency is less than 20 HZ and is an ultrasound when its frequency is more than 20 KZ. The human voice range only occupies a narrow part of the voice range which can be heard by the people, and is generally within 100 HZ-8 KHZ. 200-4000 HZ is referred to as a voice fundamental frequency, and frequencies at which most people speak are all in this range. There is an overlap between the frequency range of many instruments and the voice range. However, most of environmental noises in life, such as cooking, collision, etc., can be separated from human voice through frequency analysis. The human ear is most keen for audio near 3 KHZ. Therefore, it can be determined whether the current voice call is a voice call between normal users by judging whether the frequency of the detected input or output audio signal belongs to the human voice range. That is, when both frequencies of the input and output audio signals are not in the human voice range, it is considered that it is an abnormal call state, i.e., the mobile terminal is in the idle call state.

On the other hand, the human voice can also be separated from the environmental noise through the intensity of voice. In general, when people talk towards a phone, the intensity of the human voice experienced by a microphone is much larger than the intensity of the environmental noise. The intensity of voice of an ordinary person on a call is approximately in a range of 30-100 dB, and the intensity of voice in an ordinary conversation is approximately in 60-70 dB. If the mobile phone detects that the intensity of voice received by both sides for a long time is smaller than the intensity of voice during a conversation of normal persons, it may be considered that the mobile phone is possibly in an idle call state, and thus the user is prompted or even the phone is hung up.

It is an existing technology in the voice processing field to simply detect from the environment whether a human voice is input, but there is no precedent to apply the technology in the mobile phone voice call processing at present.

On basis of the above principle of judging whether a human voice is input based on frequency and intensity, the frequency detection of the audio signal may preferably be used as a primary judgment basis, and the intensity detection of the audio signal is used as an auxiliary judgment basis. That is, the state of the mobile terminal is judged primarily by detecting whether the frequency of the audio signal belongs to the human voice range, and whether the mobile terminal is in an idle call state is secondary judged by detecting the intensity of the audio signal. That is, once it is detected that the frequency of the audio signal exceeds the human voice range, it can be judged that the mobile terminal is in the idle call state. When it is detected that the frequency of the audio signal does not exceed the human voice range, it can further be judged through the intensity of the audio signal whether the terminal is in the idle call state.

In addition, the mode of detecting whether the mobile phone is in the idle call state may further comprise: in the process of a voice call, a gravity sensor in the mobile terminal detecting X, Y and Z values of the mobile terminal in real time, and only if the detected X, Y and Z values are not changed within set duration, detecting whether the mobile terminal is in the idle call state.

Said principle of detecting whether the mobile terminal is in the idle call state through a gravity sensor is that after the call is started, the mobile phone compares the X, Y and Z values detected by the gravity sensor once every predetermined time. If the X, Y and Z values of the gravity sensor do not change within set duration (for example, said first time threshold), it is considered that the user has put down the mobile phone and the mobile phone is not in a phone-hold call state, i.e., the mobile terminal is in an idle call state. It should be illustrated that the X, Y and Z values of the gravity sensor not changing in the present embodiment means that the change of the X, Y and Z values within set duration is in an allowable change range, i.e., there is a small change. For example, the allowable change range of xyz of the existing sensor is (0.114, −0.191, 9.845), which is a change in the second and third decimal places of that number (which may due to a vibration in the environment). Specifically, the operating principle of the gravity sensor is generally that due to the deformation of an internal crystal, a voltage signal is generated and a voltage output is formed to be transferred to a signal processing module of a mobile terminal.

It should be further illustrated that in order to reduce misjudgment conditions, said modes of determining whether the mobile terminal is in an idle call state through frequency and/or intensity of the input voice and the gravity sensor can be combined, i.e., whether the user is on a call with a phone in hand or has put down the mobile phone is firstly judged through a gravity sensor, and when it is determined that the user has put down the mobile terminal, whether the mobile terminal is really in an idle call state is then further judged through frequency and/or intensity judgment on the input voice.

Said process of the abnormal call of the mobile terminal will be described in detail below in conjunction with specific applications.

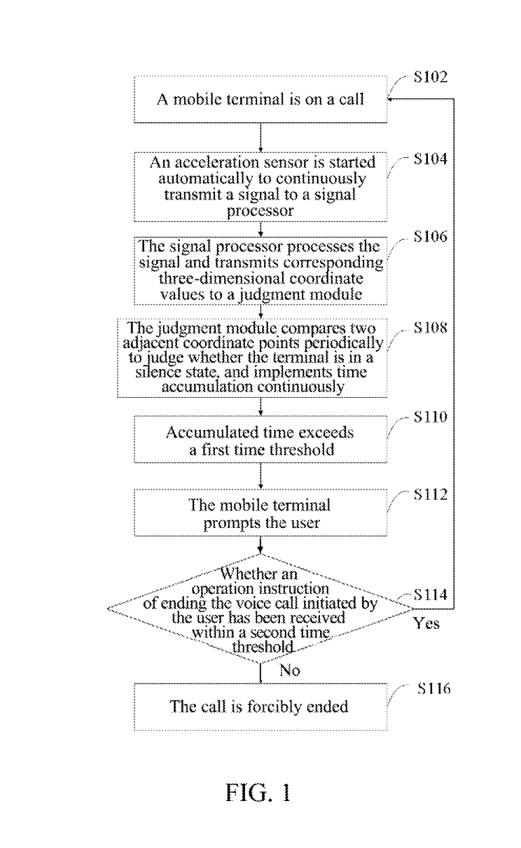

In a case that the mobile terminal has a gravity sensor, the process of an abnormal call may be performed on the abnormal call through a motion state. As shown in FIG. 1, the process includes the following steps.

In step S102, a mobile terminal is on a call, and a user (or terminal by default) starts an abnormal call prompt function.

In step S104, after the voice call is started, an acceleration sensor is started synchronously to transmit a piezoelectric signal to a signal processor for process.

In step S106, the signal processor transforms the signal value into three-dimensional coordinate values XYZ of the mobile terminal.

In step S108, a distance between (or sizes of) first two coordinate points is calculated periodically, and if the distance is 0 or a difference between the sizes is very small, it is judged that the mobile terminal is in a silence state, and a timer T1 is started.

In step S110, accumulated time exceeds a first time threshold.

Wherein, when differences between several continuous coordinate points and a previous coordinate point are suddenly very large in a time period when the value of T1 has not exceeded the first time threshold, the value of T1 is reset.

In step S112, the mobile terminal prompts the user in accordance with a preset prompt mode (such as in a form of combination of voice, vibration, picture, video etc.).

In step S114, the mobile terminal detects whether an operation instruction of ending the voice call initiated by the user (including an operation on the touch screen or keyboard of the mobile phone) has been received within a second time threshold, and if yes, the process returns to step S102; otherwise, the process proceeds to step S116.

In step S116, the mobile phone forcibly ends the call.

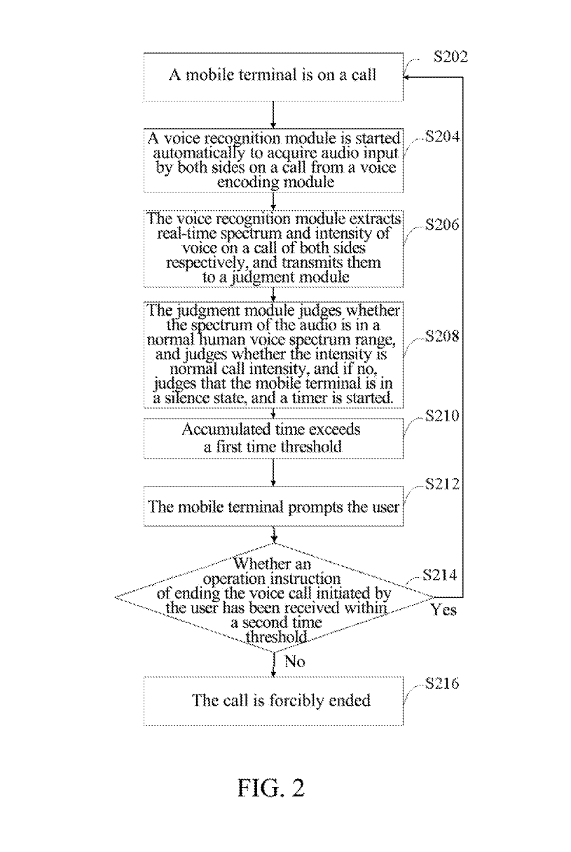

FIG. 2 illustrates a specific process of processing an abnormal call through an audio input, which comprises the following steps.

In step S202, a mobile terminal is on a call, and a user (or terminal by default) starts an abnormal call prompt function.

In step S204, after the voice call is started, a voice recognition module is started synchronously to acquire audio input by both sides on a call from a voice encoding module.

In step S206, the voice recognition module extracts real-time spectrum and intensity of voice on a call of both sides respectively, and transmits them to a judgment module.

In step S208, the judgment module periodically judges whether the spectrum of the audio is in a normal human voice spectrum range, and then auxiliarily judges whether the intensity is normal call intensity, and if both the spectrum and intensity of voice do not comply with the human voice call characteristic, judges that the mobile terminal is in a silence state, and a timer T2 is started.

In step S210, accumulated time exceeds a first time threshold.

Wherein, the judgment module continues to periodically detect whether the audio input complies with the human voice characteristic in a time period when the value of T2 has not exceeded the first time threshold, and when a call input is received before the accumulation expires, the value of T2 is reset.

In step S212, the mobile terminal prompts the user in accordance with a preset prompt mode (such as in a form of combination of voice, vibration, picture, video etc.).

In step S214, the mobile terminal detects whether an operation instruction of ending the voice call initiated by the user (including an operation on the touch screen or keyboard of the mobile phone) has been received within a second time threshold, and if yes, the process returns to step S202; otherwise, the process proceeds to step S216.

In step S216, the mobile phone forcibly ends the call.

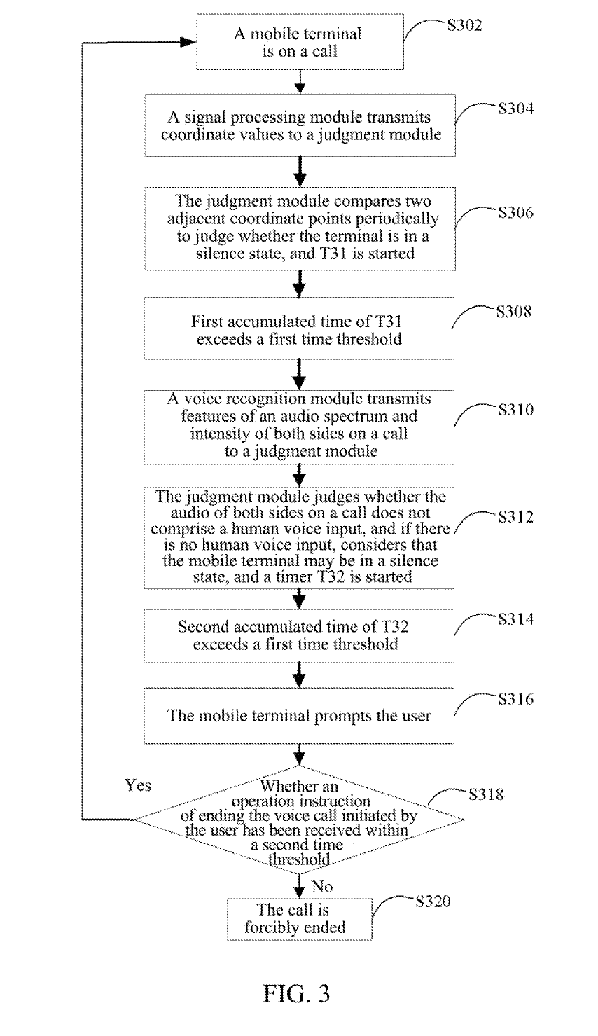

If the modes using an operation state and an audio input are combined at the same time for processing the abnormal call, as shown in FIG. 3, the process comprises the following steps.

In step S302, a mobile terminal is on a call, and a user (or terminal by default) starts an abnormal call prompt function.

In step S304, after the voice call is started, an acceleration sensor is started synchronously to transmit a piezoelectric signal to a signal processor for process, and the signal processor transforms the signal value into three-dimensional coordinate values XYZ of the mobile terminal and transmits the values to a judgment module.

In step S306, a distance between or sizes of first two coordinate points is calculated periodically by the judgment module, and if the distance is 0 or a difference between the sizes is very small, it is judged that the mobile terminal is in a silence state, and a timer T31 is started.

In step S308, accumulated time of T31 exceeds a first time threshold.

In this step, when differences between several continuous coordinate points and a previous coordinate point are suddenly very large in a time period when the value of T31 has not exceeded the first time threshold, the value of T31 is reset and the process returns to step 306.

In step S310, a voice recognition module is started automatically to acquire audio input by both sides on a call from a voice encoding module; and the voice recognition module compares the voice input of both sides, and transmits features such as an audio spectrum and intensity etc. of both sides to a judgment module.

In step S312, the judgment module periodically judges whether the audio of both sides does not comprise a human voice input according to the range of features such as spectrum and intensity etc. of the human voice, and if it is confirmed that there is no call input on both sides, judges that the mobile terminal may be in a silence state, and a timer T32 is started.

In step S314, accumulated time of T32 exceeds a first time threshold.

In this step, the judgment module continues to periodically detect whether the audio input complies with the human voice characteristic in a time period when the value of T21 has not exceeded the first time threshold, and when a call input is received before the accumulation expires, the value of T2 is reset, and the process returns to step 306.

In step S316, the mobile terminal prompts the user in accordance with a preset prompt mode (such as in a form of combination of voice, vibration, picture, video etc.).

In step S318, the mobile terminal detects whether an operation instruction of ending the voice call initiated by the user (including an operation on the touch screen or keyboard of the mobile phone) has been received within a second time threshold, and if yes, the process returns to step S302; otherwise, the process proceeds to step S320.

In step S320, the mobile phone forcibly ends the call.

### Embodiment Two

The present embodiment describes a mobile terminal, which at least comprises:

a detection unit, in the process of a voice call, detects whether the mobile terminal is in an idle call state, and when it is detected that the mobile terminal is in the idle call state, notifies a voice call module that the mobile terminal is in the idle call state;

the voice call module, after receiving the notification that the mobile terminal is in the idle call state, in accordance with a preset mode, prompts a user that the voice call has ended, or directly hangs up the voice call, or hangs up the voice call after prompting the user that the voice call has ended. It should be illustrated that the voice call module in the present embodiment adds an abnormal call prompt function.

The specific process of the voice call module hanging up the voice call after prompting the user that the voice call has ended comprises after prompting the user that the voice call has ended in accordance with a preset mode, further judging whether an operation instruction of ending the voice call initiated by the user has been received within set duration or when a number of prompts has achieved a set value, and automatically hanging up the voice call if both of them are not received.

Said detection unit may comprise a voice recognition module and a judgment module.

The voice recognition module detects input and output audio signals in real time in the process of a voice call.

The judgment module determines that the mobile terminal is in the idle call state when the input and output audio signals have not been detected by the voice recognition module within set duration.

Specifically, a voice recognition module is preset in the mobile phone. In the process of a call, the voice recognition module performs judgment through the input audio (i.e., output audio signal) of the local phone and the voice input (i.e., input audio signal) of the counterpart phone transmitted through a network, to detect whether there is a voice input at both the counterpart phone and the local phone, or detect whether the frequency of the detected audio signal corresponds to the human voice frequency range. Whether the intensity of the detected audio signal is in a normal human voice range is determined, and if the voice input module judges there is no voice input at both sides (i.e., both the input audio signal and the output audio signal can not be detected) for a long time (for example, said first time threshold), it may be considered that both sides have ends the call but have not hung up in time.

In some other schemes, when detecting an input or output audio signal, said voice recognition module further detects the frequency and/or intensity of the detected input or output audio signal. At this time, when the voice recognition module detects that the frequency and/or intensity of all detected audio signals exceed the human voice range within set duration, the judgment module determines that the mobile terminal is in the idle call state.

In addition, in a preferable scheme, in consideration that when a user make a call with a mobile phone in hand, the user may move or change a gesture in a certain time, the mobile terminal may be added with a gravity sensor to judge whether the user is on a call. Specifically, the gravity sensor detects X, Y and Z values of the mobile terminal in real time in the process of a voice call; and the detection unit detects whether the mobile terminal is in the idle call state only if the X, Y and Z values detected by the gravity sensor are not changed within set duration.

Of course, the above detection unit may also only include a gravity sensor and a judgment module. Wherein, the gravity sensor detects X, Y and Z values of the mobile terminal in real time in the process of a voice call; and the judgment module can determine that the mobile terminal is in the idle call state when the X, Y and Z values detected by the gravity sensor are not changed within set duration.

In the above description, whether the mobile phone is in an idle abnormal call state is determined by detecting a motion state or audio input of a mobile terminal, and the user is prompted. In practice, in the method mentioned in the present invention, the present invention may also be implemented in other modes, such as detecting whether a human body approaches a sensor or infrared etc. There is no obvious difference between the principle thereof and the above two modes, and thus, the description thereof will be omitted here.

A person having ordinary skill in the art can understand that all or a part of steps in the above method can be implemented by programs instructing related hardware, and the programs can be stored in a computer readable storage medium, such as a read-only memory, disk or disc etc. Alternatively, all or a part of steps in the above embodiments can also be implemented by one or more integrated circuits. Accordingly, each module/unit in the above embodiments can be implemented in a form of hardware, or can also be implemented in a form of software functional module. The present application is not limited to any particular form of a combination of hardware and software.

The above description is only the preferred embodiments of the present invention and is not intended to limit the protection scope of the present invention. Any modification, equivalent substitution, improvement etc. which are made within the spirit and principle of the present invention should belong to the protection scope of the present invention.

### INDUSTRIAL APPLICABILITY

The embodiments of the present invention can achieve expected effects only by making few variations on the mobile terminal, without changing software and hardware on a large scale.

1. An abnormal call processing method of a mobile terminal, comprising:
in the process of a voice call, a mobile terminal detecting whether the mobile terminal is in an idle call state in real time, and when it is detected that the mobile terminal is in the idle call state, prompting in accordance with a preset mode a user that the voice call has ended, or automatically hanging up the voice call, or hanging up the voice call after prompting the user that the voice call has ended.

2. The method according to claim 1, wherein, the process of the mobile terminal hanging up the voice call after prompting in accordance with a preset mode the user that the voice call has ended comprises:
the mobile terminal prompting the user that the voice call has ended in accordance with a preset mode, and if an operation instruction of ending the voice call initiated by the user has not been received within set duration or when a number of prompts has achieved a set value, automatically hanging up the voice call.

3. The method according to claim 2, wherein, the process of detecting whether the mobile terminal is in an idle call state comprises:
in the process of a voice call, the mobile terminal detecting input and output audio signals in real time, and if the input and output audio signals have not been detected within set duration, determining that the mobile terminal is in the idle call state.

4. The method according to claim 3, wherein,
if the input or output audio signal is detected, judging whether a frequency and/or intensity of the detected audio signal is within a human voice range, and if the frequencies or intensities of all the detected audio signals exceed the human voice range within set duration, determining that the mobile terminal is in the idle call state.

5. The method according to claim 3, wherein, the method further comprises:
in the process of a voice call, a gravity sensor in the mobile terminal detecting X, Y and Z values of the mobile terminal in real time, and detecting whether the mobile terminal is in the idle call state only if the detected X, Y and Z values are not changed within set duration.

6. The method according to claim 1, wherein, the process of detecting whether the mobile terminal is in an idle call state comprises:
in the process of a voice call, a gravity sensor in the mobile terminal detecting X, Y and Z values in real time, and if the detected X, Y and Z values are not changed within set duration, determining that the mobile terminal is in the idle call state.

7. A mobile terminal, comprising:
a detection unit, configured to: in the process of a voice call, detect whether the mobile terminal is in an idle call state, and when it is detected that the mobile terminal is in the idle call state, notify a voice call module that the mobile terminal is in the idle call state;
the voice call module, configured to: upon receiving the notification that the mobile terminal is in the idle call state, prompt in accordance with a preset mode a user that the voice call has ended, or automatically hang up the voice call, or hang up the voice call after prompting the user that the voice call has ended.

8. The mobile terminal according to claim 7, wherein,
the voice call module is configured to: when hanging up the voice call after prompting the user that the voice call has ended, firstly prompt the user that the voice call has ended in accordance with the preset mode, and if an operation instruction of ending the voice call initiated by the user has not been received within set duration or when a number of prompts has achieved a set value, automatically hang up the voice call.

9. The mobile terminal according to claim 8, wherein, the detection unit comprises:
a voice recognition module, configured to detect input and output audio signals in real time in the process of a voice call,
a judgment module, configured to determine that the mobile terminal is in the idle call state when the input and output audio signals have not been detected by the voice recognition module within set duration.

10. The mobile terminal according to claim 9, wherein,
the voice recognition module is further configured to detect a frequency and/or intensity of an input or output audio signal when the audio signal is detected;
the judgment module is configured to determine that the mobile terminal is in the idle call state when the voice recognition module detects that the frequency and/or intensity of the audio signal exceeds the human voice range in set duration.

11. The mobile terminal according to claim 9, further comprising:
a gravity sensor, configured to detect X, Y and Z values of the mobile terminal in real time in the process of a voice call;
the detection unit, configured to detect whether the mobile terminal is in the idle call state only if the X, Y and Z values detected by the gravity sensor are not changed within set duration.

12. The mobile terminal according to claim 7, wherein, the detection unit comprises:
a gravity sensor, configured to detect X, Y and Z values of the mobile terminal in real time in the process of a voice call;
a judgment module, configured to determine that the mobile terminal is in the idle call state when the X, Y and Z values detected by the gravity sensor are not changed within set duration.

13. The method according to claim 4 further comprising:
in the process of a voice call, a gravity sensor in the mobile terminal detecting X, Y and Z values of the mobile terminal in real time, and detecting whether the mobile terminal is in the idle call state only if the detected X, Y and Z values are not changed within set duration.

14. The method according to claim 2 wherein the process of detecting whether the mobile terminal is in an idle call state comprises:
in the process of a voice call, a gravity sensor in the mobile terminal detecting X, Y and Z values in real time, and if the detected X, Y and Z values are not changed within set duration, determining that the mobile terminal is in the idle call state.

15. The mobile terminal according to claim 10 further comprising:
a gravity sensor, configured to detect X, Y and Z values of the mobile terminal in real time in the process of a voice call;
the detection unit, configured to detect whether the mobile terminal is in the idle call state only if the X, Y and Z values detected by the gravity sensor are not changed within set duration.

16. The mobile terminal according to claim 8 wherein the detection unit comprises:
a gravity sensor configured to detect X, Y and Z values of the mobile terminal in real time in the process of a voice call;
a judgment module configured to determine that the mobile terminal is in the idle call state when the X, Y and Z values detected by the gravity sensor are not changed within set duration.
